(19) United States
(12) Patent Application Publication
(10) Pub. No.: US 2004/0075539 A1
(43) Pub. Date: Apr. 22, 2004

(54) Vehicle monitoring system

(76) Inventors: Paul-Andre Savoie, Laval (CA); Jacques Duchesneau, Ottawa (CA)

Correspondence Address: PEARNE & GORDON LLP, 1801 EAST 9TH STREET, SUITE 1200, CLEVELAND, OH, 44114-3108, US

(21) Appl. No.: 10/349,269

(22) Filed: Jan. 22, 2003

Related U.S. Application Data
(60) Provisional application No. 60/349,415, filed on Jan. 22, 2002.

(51) Int. Cl. B60R 25/10

(52) U.S. Cl. 340/426.1

(57) ABSTRACT

The invention is directed to a vehicle monitoring system, which determines a possible theft condition by detecting that a vehicle has been displaced while at the same time it has sensed that there has not been a key entry in the ignition and/or the vehicle's motor is not running. The system includes a control module mounted in the vehicle and a service provider server installed at a predetermined location by a service provider. The control module includes a processor, a Global Positioning System receiver or a motion sensor for determining the displacement of the vehicle, a wireless communications unit and an interface for connecting the processor to the vehicle's key entry sensor and motor running sensor. When a possible theft condition is determined, the service provider server will generate a message to alert a security agency. The agency will then access the client's web page on the server to see the data and the status of the vehicle and through an action menu on the web page, take any action warranted, such as forwarding vehicle theft in progress message to the police. The vehicle may then be tracked in real time by a GPS for quick and efficient recovery.

This application claims the benefit of U.S. Provisional Patent Application Serial No. 60/349,415 filed on Jan. 22, 2002.

### FIELD OF THE INVENTION

The invention relates generally to vehicle monitoring systems and more particularly to a method and system for detecting the potential theft of a vehicle.

### BACKGROUND OF THE INVENTION

One vehicle is stolen every 4 minutes in Canada. Almost one out of every 100 cars is stolen every year, that's about 442 cars per day. As a result, every year, 10% to 12% of automobile insurance premiums are dedicated to compensating victims of vehicle theft.

Close to 40% of stolen vehicles are found, usually after the thieves used them to get around or to commit other crimes. About 45% of the remaining vehicles are transformed into car parts in the hours following the theft, and are distributed to various resellers in the country and abroad. A car disassembled for parts is worth three to five times its original sale price. Other vehicles are exported illegally by loading them into shipping containers. It is therefore important to accurately detect the theft of a vehicle as soon as possible after the event so that the vehicle can be tracked and the police alerted in order to enable them to apprehend the thieves before the vehicles are dismantled or loaded into containers.

Various systems have been developed for detecting the theft of a vehicle such as described in U.S. Pat. No. 6,232,873 which issued to Dilz et al on May 15, 2001 or for tracking a stolen vehicle such as described in U.S. Pat. No. 5,917,405 which issued to Joao on Jun. 29, 1999 or U.S. Pat. No. 5,895,436 which issued to Savoie et al on Apr. 20, 1999 have been developed. Though these systems have been successful in detecting and/or tracking stolen vehicles to some extent, they do not constitute a completely satisfactory system.

Therefore, there is a need for an improved vehicle monitoring system for theft detection.

### SUMMARY OF THE INVENTION

The invention is directed to a method and apparatus for remotely monitoring a vehicle for possible theft conditions. The method includes a control module for detecting displacement of the vehicle, sensing vehicle key entry or its equivalent, and sensing vehicle motor operation, whereby possible theft conditions exist when the vehicle has been displaced without key entry and/or the motor running.

In accordance with a further aspect of this invention, the method and apparatus includes sending the possible theft conditions for the vehicle to a service provider server for use by a security agency associated with the vehicle, whereby the security agency receives an alert message regarding the possible theft conditions. A similar alert message may be sent to a police department by the security agency either before or after a confirmation by the client that the vehicle is being stolen.

In accordance with another aspect of the invention, access to descriptive information regarding the vehicle and mapping information of the vehicle location determined by a GPS receiver and displayed in real time as it is displaced may be provided to the security agency and/or police department through a web page on the service provider server.

In accordance with a specific aspect of the invention, the monitoring apparatus may include a displacement detector, which may be a global positioning system receiver or a motion sensor, and a wireless radio unit to communicate between the control module and the service provider server.

With regard to another aspect of the invention the vehicle monitoring system comprises a control module for mounting within the vehicle, a service provider server having a web page for the vehicle, and a wireless communications unit for communicating between the control module and the service provider server. The wireless communications unit may be a cellular radio using a short-message service (SMS) or a general packet radio service (GPRS).

In accordance with another aspect of the invention, the control module comprises a computer processor, a device coupled to the processor for determining vehicle displacement, a device coupled to the processor for sensing vehicle key entry and a device coupled to the processor for sensing vehicle motor operation.

In accordance with a further aspect of the invention, the vehicle displacement determining device includes a global positioning system receiver or a motion sensor, and displacement may be determined by distance traveled by the vehicle or by speed of the moving vehicle.

With regard to a further specific aspect of the invention, the processor may be coupled to the vehicle for controlling vehicle equipment such as door locks, motor starter, horn, four-way flashers and anti-starter mechanism.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a schematic of the basic control module in accordance with the present invention;

FIG. 2 is a schematic of a vehicle monitoring system; and

FIG. 3 illustrates the steps in operating the system.

### DETAILED DESCRIPTION OF THE INVENTION

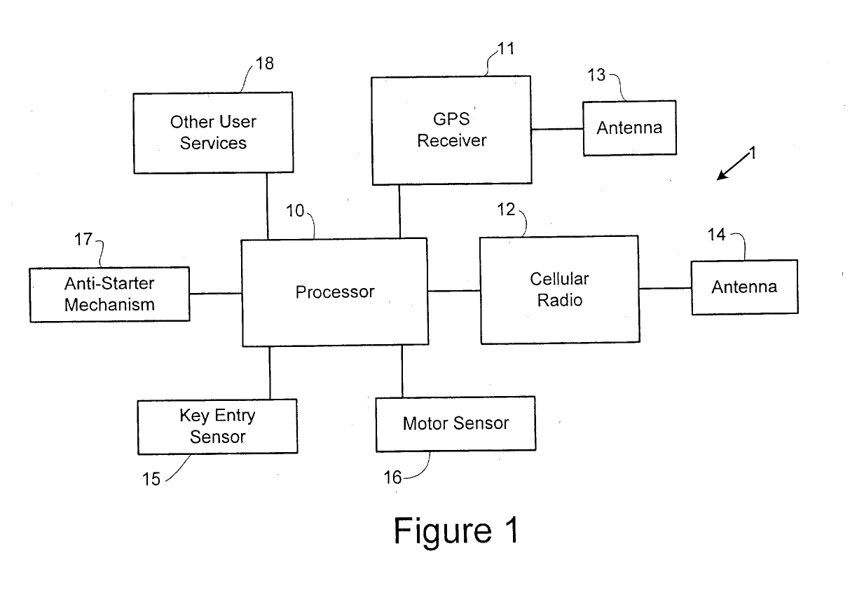

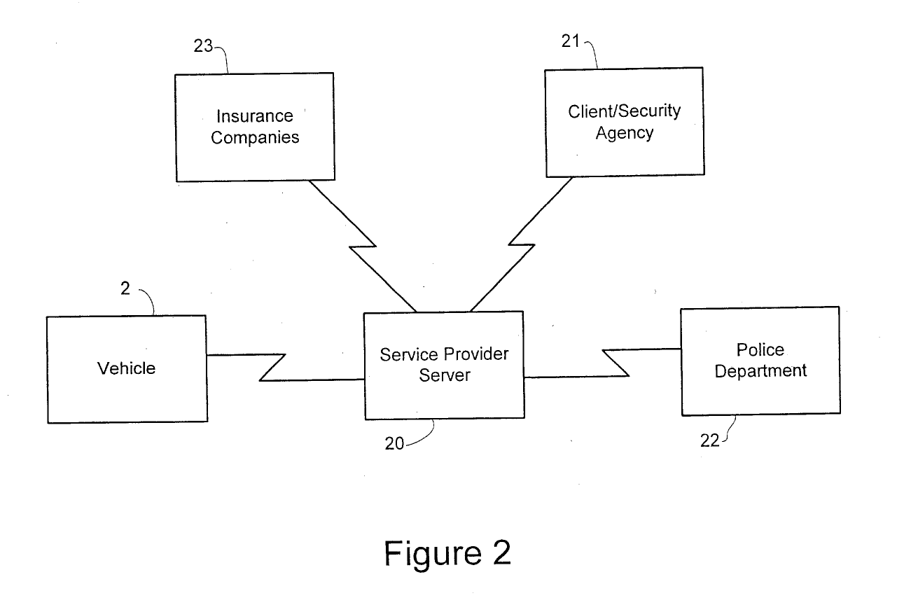

The control module 1, as illustrated in FIG. 1, for the vehicle monitoring system is installed in the vehicle to be monitored. It would normally be hidden within the vehicle where it would not be easily found or accessed by a thief. The basic control module includes a computer processor 10 coupled to a Global Positioning System (GPS) receiver 11 and a wireless radio unit 12. The GPS receiver 11, which includes a GPS antenna 13, periodically receives the location of the vehicle at intervals in a standard manner, which usually occurs at rates in the order of once per second. The GPS receiver 11 may then provide the processor 10 displacement data such as vehicle position, vehicle distance moved or vehicle speed. The wireless radio unit 12 may be based on GSM cellular standards using the Short-Message Service (SMS) or the General Packet Radio Service (GPRS). Unit 12 also includes a cellular antenna 14, such as a GSM antenna with specifications according to Motorola GSM radio products. To facilitate installation, the two antennas may be replaced by a dual band stealth GPS and Cellular antenna. The cellular radio unit 12 is used to communicate with a service provider server 20 to be described below with respect to FIG. 2. The computer processor 10 monitors the status of the vehicle and generates data, which is sent to server 20. The processor 10 may also be used to control certain functions of the vehicle in response to the status of the vehicle or in response to instructions received from the server 20.

The processor 10 is further coupled to the vehicle's key entry sensor 15 or its equivalent-as well as the vehicle's motor operating sensor 16. If sensors 15 and 16 are non-existent in a vehicle to be protected by the system in accordance with the present invention, these types of sensors or their equivalents must be installed in the vehicle. In the embodiment of the control module 1 described above, vehicle displacement data is provided by a GPS receiver 11, however, other devices such as motion sensors may be used to provide displacement data to the processor 10.

In order to determine whether a possible theft of the vehicle is taking place, the processor 10 monitors the key entry sensor 15 and the motor operating sensor 16, as well as the GPS 11 receiver, these key factors are used to determine whether the vehicle is being displaced in an abnormal manner or whether it is being displaced in a normal manner, where the vehicle's key is in the ignition barrel and the motor is running. Table 1 illustrates possible theft situations as well as normal situations.

TABLE 1

| | Sense Vehicle | Sense Key | Sense Motor | Possible Theft |
|---|---|---|---|---|
| Situation | Displacement | Entry | Running | Condition |
| 1. | Yes | No | No | Yes |
| 2. | Yes | Yes | No | Yes |
| 3. | Yes | No | Yes | Yes |
| 4. | No | No | Yes | Yes |
| 5. | No | No | No | No |
| 6. | No | Yes | No | No |
| 7. | No | Yes | Yes | No |
| 8. | Yes | Yes | Yes | No |

As shown in table 1, the processor 10 will detect a possible theft condition if it receives displacement data indicating that the vehicle has been moved a predetermined distance or has been moved at a predetermined speed, and at least one of the other two factors, i.e. key entry and motor running, are not sensed. The distance or speed of the vehicle displacement is selected such that it is well within the capability of a standard GPS receiver 11, though the GPS measured distance or speed may vary from system to system or even from vehicle to vehicle depending on the specifications of the equipment being used, as well as the need to avoid false alarms.

In the first three situations shown in Table 1, the vehicle has been detected by the processor 10 as having been displaced over a predetermined period of time. To do so, the processor 10 receives vehicle displacement data from the GPS receiver 11 periodically to determine whether displacement has occurred. Simultaneously, in the first case neither the key entry, or its equivalent, nor the motor running is sensed, in the second case the motor running is not sensed and in the third case key entry is not sensed. Thus in situations 1 and 2, processor 10 determines that the vehicle has been displaced without the motor running which indicates that the vehicle is being towed. In case 3, the motor is running, however without an authentic key in the ignition, which again indicates that the vehicle is being illegally displaced. In situations 1 and 3, the processor 10 may transmit this data to the service server 20 or the processor 10 may generate an alarm signal to be transmitted to the server 20. In either case, the situation data indicating the vehicle's condition that instigated the alarm signal may be transmitted to the service server 20. In situation 2, the conditions are such that in many circumstances a theft is not occuring since it is a situation where the vehicle is being towed with the presence of an authentic key. Thus in some embodiments of the present invention, this condition may not be made to generate an alarm signal to the server 20, though the processor 10 may simply transmit the situation data to the server 20.

Situation 4 may constitute an early warning of a vehicle in the process of being stolen. In this case, the vehicle has not been displaced, however, the motor is running without an authentic key in the ignition. The processor 10 may also generate an alarm signal to be transmitted to the server 20, again with data indicating the circumstance of the alarm signal, or may simply transmit the situation data to the server 20 where it is processed.

Situations 5 to 8 do not generate an alarm status since they represent conditions that are normal for a vehicle. In case 5, the vehicle is not being displaced, the motor is not running and there is no key in the ignition. Cases 6 and 7 simply illustrate the process sequence for starting a vehicle, in case 6 the key is inserted into the ignition and in case 7 the motor is started without displacement of the vehicle. Finally, in case 8, the vehicle is being displaced with the motor running and an authentic key in the ignition.

It is to be noted from the above table 1 that one particular advantage of the present invention is that a possible theft condition is indicated when key entry, or its equivalent, or motor running is not sensed. In this way, if one of these sensors 15 or 16 is faulty or has been disabled, the default position of the system will be to indicate a possible theft condition, which may be further investigated by the service provider through server 20.

As indicated above, the processor 10 in the control module 1 may further be used to control certain vehicle hardware either as part of the theft prevention function or to provide other user services. As illustrated in FIG. 1, the vehicle may be equipped with an anti-starter mechanism 17. Such a mechanism may be installed along the vehicle's steering column and connected so as to prevent the vehicle from being started. Vehicle anti-starter mechanisms normally operate in conjunction with the key sensor 15 such that all power to the vehicle's ignition system is cut-off if the vehicle's key is not sensed in the ignition key barrel. In addition, the mechanism 17 may be coupled to the processor 10 so that the processor 10 is aware when the mechanism 17 is or is not activated. This added data that may be transmitted to the server 20 periodically. The processor 10 may also control certain hardware in a vehicle such as the horn or four-way flashers, which may be activated by the processor 10 directly when an alarm status is generated or under instruction from the server 20. Further end-user services 18 may be provided through the processor 10 under instructions from the server 20 such as the locking and unlocking of the vehicle doors, and the remote starting of the vehicle's motor. In addition, the processor 10 may also be used to periodically verify the operational status of the control module, to provide vehicle location information and real-time vehicle tracking information to the server 20.

Thieves may attempt to disable the control module 1 by tampering with the sensors 15, 16, by disconnecting the vehicle's battery from the module or even jamming the GPS 11 and/or the cellular radio 12 frequencies. The processor 10 may therefore be programmed to send messages to the server 20 alerting it of these unauthorized activities.

The system also includes methods to detect abnormal wireless radio and/or GPS conditions and act upon them. For instance, energy levels on all radio control channels are monitored for non-conformities with respect to proper network operation behavior. If such a non-conformity is detected, then the processor 10 will control the radio 12 to transmit an alert message on all available channels to warn the service provider server 20. This action can be complemented or replaced with a control of certain vehicle hardware.

Likewise, if non-conformities of incoming GPS signals from the antenna 13 are detected, then an alert message will be sent to the service provider server 20. Control of some vehicle harware can also replace or complement this action. The alert message received by the service provider server 20 may inform the security agency 21 to alert the police to base the vehicle search on the localization information collected by the radio network.

As indicated above, the control module 1 that is located in a vehicle is coupled through a wireless radio unit 12 to a service provider server 20. The service provider server 20 is a multi-function device. In addition to receiving vehicle situation data from the control module 1, including a possible theft condition, the server 20 may transmit information and/or instructions to the vehicle control module 10 to control certain vehicle functions such as locking and unlocking the vehicle doors, starting the vehicle motor, disabling the vehicle ignition system, operating the horn and the flashers, and the like. However, in addition as shown in FIG. 2, service provider server 20 in the system communicates with the clients through a security agency 21 to alert the vehicle owner of the status of his/her vehicle, and may also communicates with the appropriate police force 22 either directly or through the security agency 21 when necessary to alert them of a possible stolen vehicle. The security agency 21 may be a unit within the service provider, a separate independent unit or even a unit within an organization such as an insurance company or a police department. The server 20 also provides access to the security agency 21 to a web page with all available data regarding the vehicle; this same data at least in part may also be made accessible to the police department either directly or through the security agency 21. The data may include real time vehicle location information obtained from the GPS receiver 11. Finally, server 20 may, with the authorization of the clients, provide access, on a need to know basis to insurance companies 23 to provide them with information regarding the operational status of the client's vehicle monitoring system. To this end, it is particularly advantageous for the server 20 to receive the operational status of the control module on a regular basis.

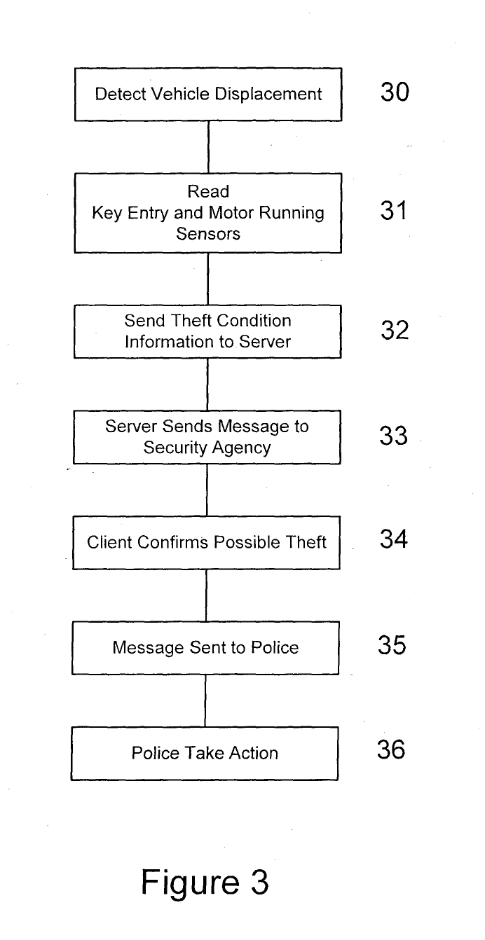

The process for operating the vehicle monitoring system as illustrated in FIG. 3 comprises detecting that the vehicle has been displaced a predetermined distance or at a predetermined speed using the processor 10—step 30, reading the key entry sensor 15 and the motor running sensor 16 by the processor 10—step 31—to determine whether the key has been entered and/or the motor is running. If one or both of these conditions are not met, the processor 10, through the cellular radio 12, will transmit the possible theft condition information to the service provider server 20—step 32. The service provider server 20 will communicate with the security agency 21 by e-mail, cell phone, pager or some other rapid means to alert the security agency 21 of the situation—step 33. In addition, the message communicated contains a WWW link to a client profile page containing information such as the vehicle description, client contact information, a map showing the vehicle's location derived from the GPS receiver 11, a series of questions for the client to respond to, and an action menu with the next steps to follow which could include alerting the police department 22. The security agency 21 will contact the client to confirm that a possible theft is in progress—step 34—and, if so, the security agency will alert the police department 22—step 35. The police 22 will take action with the assistance of the security agency 21—step 36—which may give the police department indirect or direct access to the information on the web page displaying the client's profile which includes the make, model, colour and other data on the car in question, the written input from the client or his security officer stating that they consider that a theft is in progress, as well as mapping information that displays the vehicle's location as it moves in real time. If the client does not respond to the security agency 21, the security agency 21 may alert the police department 22 with or without conferring with the service provider. The police will then be able to dispatch a vehicle to intercept the stolen vehicle. In some systems, the police may also be able, through the web page, to activate the horn or four-way flashers or remotely enable the anti-starting mechanism to ensure that the car cannot be re-started once the motor is stopped.

It is to be noted that the above scenario is equally applicable whether the vehicle is being stolen by hot wiring the vehicle and driving the vehicle away or by simply towing the vehicle away. In the latter case however, when the key is sensed, there are certain towing situations that do not warrant police intervention. For instance, if a car is being towed due to an accident or some similar situation, the client may be aware of the situation and the security agency will not send a message to the police department. The security agency 21 may opt to determine from the mapping information where the vehicle is being towed before taking any further action.

The above system allows the police 22 to take action immediately while the theft is in progress maximizing the chance of retrieving the vehicle quickly with little damage to the vehicle and with the contents of the vehicle still intact.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A method of remotely monitoring a vehicle for possible theft conditions comprising:
detecting displacement of the vehicle;
sensing vehicle key entry; and
sensing vehicle motor operation, whereby possible theft conditions exist when the vehicle has been displaced without key entry and/or the motor running.

2. A method of remotely monitoring a vehicle as claimed in claim 1, which further includes providing the possible theft conditions for the vehicle to a service provider server for use by a security agency associated with the vehicle.

3. A method of remotely monitoring a vehicle as claimed in claim 2, which further includes sending a message regarding the possible theft conditions to the client.

4. A method of remotely monitoring a vehicle as claimed in claim 3, which further includes receiving confirmation from the client that the vehicle is being stolen.

5. A method of remotely monitoring a vehicle as claimed in claim 3, which further includes sending a message regarding the stolen vehicle to a police department.

6. A method of remotely monitoring a vehicle as claimed in claim 4, which further includes sending a message regarding the stolen vehicle to a police department.

7. A method of remotely monitoring a vehicle as claimed in claim 5, which further includes providing descriptive information regarding the vehicle and mapping information for displaying the vehicle location as it moves in real time to the police department.

8. Apparatus for remotely monitoring a vehicle for possible theft conditions comprising:
means for detecting displacement of the vehicle;
means for sensing vehicle key entry; and
means for sensing vehicle motor operation, whereby possible theft conditions exist when the vehicle has been displaced without key entry and/or the motor running.

9. Apparatus for remotely monitoring a vehicle as claimed in claim 8, wherein the vehicle displacement detecting means includes a global positioning system.

10. Apparatus for remotely monitoring a vehicle as claimed in claim 8, wherein the vehicle displacement detecting means includes a motion sensor.

11. Apparatus for remotely monitoring a vehicle as claimed in claim 8, which further includes means for providing the possible theft conditions for the vehicle to a service provider server for use by a security agency associated with the vehicle.

12. Apparatus for remotely monitoring a vehicle as claimed in claim 8, which further includes means for transmitting data of the possible theft conditions for the vehicle to a service provider server for use by a security agency associated with the vehicle.

13. Apparatus for remotely monitoring a vehicle as claimed in claim 12, wherein the transmitting means includes a wireless radio unit.

14. Apparatus for remotely monitoring a vehicle as claimed in claim 12, wherein the security agency includes means for sending a message regarding the possible theft conditions to a client.

15. Apparatus for remotely monitoring a vehicle as claimed in claim 14, wherein the security agency includes means for receiving confirmation from the client that the vehicle is being stolen.

16. Apparatus for remotely monitoring a vehicle as claimed in claim 14, wherein the security agency includes means for sending a message regarding the stolen vehicle to a police department.

17. Apparatus for remotely monitoring a vehicle as claimed in claim 15, wherein the security agency includes means for sending a message regarding the stolen vehicle to a police department.

18. Apparatus for remotely monitoring a vehicle as claimed in claim 16, wherein the service provider server further includes means for providing descriptive information regarding the vehicle and mapping information for displaying the vehicle location as it moves in real time to the police department.

19. In a system for monitoring a vehicle, a control module for mounting within the vehicle comprising:
a. a computer processor;
b. means coupled to the processor for determining vehicle displacement;
c. means coupled to the processor for sensing vehicle key entry; and
d. means coupled to the processor for sensing vehicle motor operation.

20. A control module as claimed in claim 19 wherein the vehicle displacement determining means includes a global positioning system receiver.

21. A control module as claimed in claim 19 wherein the vehicle displacement determining means includes a motion sensor.

22. A control module as claimed in claim 19, which further includes a wireless communications unit for communicating with a service provider server in the vehicle monitoring system.

23. A control module as claimed in claim 22 wherein the wireless communications unit is a cellular radio using a short-message service (SMS) or general packet radio service (GPRS).

24. A control module as claimed in claim 22, which further includes an anti-starter mechanism coupled to the computer processor.

25. A control module as claimed in claim 22, wherein the computer processor includes means coupled to the vehicle for controlling vehicle equipment such as door locks, motor starter, horn, four-way flashers and anti-starter mechanism.

26. A control module as claimed in claim 19, wherein the vehicle displacement means determines displacement by distance travelled by the vehicle.

27. A control module as claimed in claim 19, wherein the vehicle displacement means determines displacement by speed of the vehicle.

28. A system for monitoring a vehicle, comprising
a control module for mounting within the vehicle having:
a computer processor;
means coupled to the processor for determining vehicle displacement;
means coupled to the processor for sensing vehicle key entry; and
a. means coupled to the processor for sensing vehicle motor operation;
b. a service provider server having a web page for the vehicle; and
c. wireless means for communicating between the control module and the service provider server.

29. A control module as claimed in claim 28 wherein the vehicle displacement determining means includes a global positioning system receiver.

30. A control module as claimed in claim 28 wherein the vehicle displacement determining means includes a motion sensor.

31. A system for monitoring a vehicle as claimed in claim 28 wherein the wireless communications unit is a cellular radio using a short-message service SMS or a genral packet radio sevice (GPRS).

32. A system for monitoring a vehicle as claimed in claim 31 wherein the service provider server includes means for communicating with a security agency associated with the vehicle.

33. A system for monitoring a vehicle as claimed in claim 31 wherein the security agency communications means includes e-mail.

34. A system for monitoring a vehicle as claimed in claim 28 wherein the web page on the service provider server includes descriptive information regarding the vehicle and the client, and mapping information for providing the location of the vehicle in real time.

35. A system for monitoring a vehicle as claimed in claim 34 wherein access to the web page is selectively provided to the security agency and/or the police department.

36. A system for monitoring a vehicle as claimed in claim 28 wherein the vehicle displacement means determines displacement by distance travelled by the vehicle.

37. A system for monitoring a vehicle as claimed in claim 28 wherein the vehicle displacement means determines displacement by speed of the vehicle.

38. A system for monitoring a vehicle as claimed in claim 28 which includes:
means for detecting abnormal radio and/or GPS conditions; and
means for alerting the service provider server of the abnormal conditions.

39. A system for monitoring a vehicle as claimed in claim 38 which further includes means coupled to the vehicle for controlling vehicle equipment.
